(19) United States
(12) Patent Application Publication
(10) Pub. No.: US 2004/0118938 A1
(43) Pub. Date: Jun. 24, 2004

(54) Apparatus for flushing debris from a sprinkler head canister

(76) Inventor: Emilio Flores, San Fernando, CA (US)

Correspondence Address: ROBERT J. SCHAAP, 21241 Ventura Boulevard, Suite 188, Woodland Hills, CA, 91364, US

(21) Appl. No.: 10/327,804

(22) Filed: Dec. 19, 2002

(51) Int. Cl. B05B 15/06; A01G 25/06

(52) U.S. Cl. 239/201

(57) ABSTRACT

An apparatus for removing debris and washing out a subterranean canister of a sprinkler head without causing a water saturation at the site of the sprinkler head. The apparatus comprises an elongate tube-like device having a first leg connected to and extending upwardly from the canister, and a second leg directed angularly away from the canister. In this way, water under pressure can be run through the canister forcing debris out of the canister, and without saturating the site of the sprinkler head.

### BACKGROUND OF THE INVENTION

1. Field of the Invention

This invention relates in general to certain new and useful improvements in a subterranean sprinkler clean-out apparatus, and more particularly, to a device for removing debris from a subterranean canister of that sprinkler head by flushing water therethrough without saturating the site of the sprinkler head.

2. Brief Description of Related Art

In large plot areas, large diameter sprinkler heads are used to provide an effective irrigation of the ground surface. Thus, and for example, in municipal parks and the like, large diameter sprinkler canisters which hold a sprinkler mechanism are mounted within the ground and connected to pipes which may have a one inch diameter or more, for example. However, frequently, debris contained in the water will collect in the canister and will tend to foul the sprinkler head. As a result, it is necessary to periodically flush the canister and remove such debris.

One of the problems in flushing the canister to remove that debris is the fact that the canister is mounted in a subterranean position. Thus, when the cap of the canister is removed and the sprinkler mechanism is also removed, additional debris tends to fall into and collect in the canister. Although this debris can be removed by flushing with water under pressure, that water, particularly for a large diameter canister, will collect in the immediate vicinity of the canister. Hence, it makes additional work around that canister quite difficult.

It may be appreciated that after flushing of the canister, it is necessary for the attendant to re-insert the sprinkler mechanism and to screw back on the cap which extends over the upper end of the canister. The work would become complicated and would soil the tools and the clothing of the attendant or workman if water collected in that particular region. In addition, because of water saturation, work on the very canister itself would potentially damage the grass or other planted material in the vicinity of the canister. It would be desirable to provide some mechanism which allowed water under pressure from a subterranean water line to pass into the canister, in order to remove debris from the interior of the canister, without saturating the actual site of the canister with the flushing water.

Another one of the problems associated with cleaning out the canister of a sprinkler head is the time required because of saturation of the ground surface. Generally, it has been found that in order to replace the sprinkler, as much as two and one-half hours of time could be required. Thus, the efficiency and productivity of the attendants attempting to maintain a sprinkler system is materially reduced.

### OBJECTS OF THE INVENTION

It is, therefore, one of the primary objects of the present invention to provide a large surface area subterranean sprinkler system clean-out apparatus, for efficiently and rapidly removing debris from a subterranean sprinkler head canister located below a ground surface, and where additional debris may otherwise fall into the canister without saturating the site of the canister with flushing water. The device thus adopts the form of a tube having a first leg extending upwardly from the canister, and a second tube having a second leg extending angularly away from the site of the canister.

It is another object of the present invention to provide a subterranean sprinkler system clean-out apparatus which includes a pipe-type arrangement for connection to the upper end of the canister, and which includes a duct having a first tubular leg to be attached to the upper end of the canister, and a second tubular leg being located to extend angularly away from the first leg, to thereby direct any water and/or debris in the canister away from the vicinity of the sprinkler head.

It is a further object of the present invention to provide a sprinkler system clean-out apparatus of the type stated, which can be easily attached to a canister of a sprinkler head after removing the cap of the sprinkler head, and after removing the sprinkler mechanism to thereby allow debris in the canister to be removed therefrom without creating water saturation in the region of the canister.

It is also an object of the present invention to provide a device for attachment to the upper end of a large surface area sprinkler head and which has an end adapted for releasable attachment to, and attachment means on, the upper end of the canister.

It is still another object of the present invention to provide a device of the type stated which can be constructed at a relatively low cost, and which is highly efficient in operation.

It is another salient object of the present invention to provide a method for cleaning out a canister of a subterranean sprinkler head assembly, with an efficient removal of debris without saturating the site of the sprinkler head with the flushing water, such that flushing water is directed away from the site of the canister.

With the above and other objects in view, my invention resides in the novel features of form, construction, arrangement and combination of parts and components presently described and pointed out in the claims.

### BRIEF SUMMARY OF THE INVENTION

The present invention relates primarily to a subterranean sprinkler clean-out apparatus, for efficiently and rapidly removing debris from a subterranean sprinkler head canister, which is located below a ground surface, and which might otherwise allow additional debris to fall into the canister when the cap thereof is removed, and where the interior sprinkler mechanism is removed. This sprinkler apparatus comprises a device having a first tubular leg having a duct which extends into the canister, and which has an end located to be attached to the upper end of the canister.

The device of the present invention also includes a second tubular leg connected to the first tubular leg, and also having a duct located to extend angularly away from the first leg. In this way, water from a subterranean pipe can be flushed into the canister and through the device having the pair of legs, to be directed away from the site of the canister.

The subterranean sprinkler system clean-out apparatus typically has the second leg integral with the first leg, or otherwise, rigidly connected thereto. In addition, the second leg extends outwardly away from the first leg at a substantial angle to the first leg, that is, at an angle, as for example, which is perpendicular to the first leg. In a more preferred embodiment of the invention, the second leg typically extends outwardly from the first leg at an angle of between about 15° to about 160°.

The canister generally has an attachment means of the type which receives a cap, such as a threaded attachment means. In this case, the sprinkler system clean-out apparatus has a lower end with an attachment means, which can attach to the upper end of the canister. Further, the duct extending between the first and second legs has a diametral size approximately the same as that of the inner wall of the canister. The duct also has a generally consistent diameter from one end to the other.

The present invention also provides a method of cleaning out a canister of a subterranean sprinkler head assembly, with efficient removal of the debris in the canister, and other debris which might collect in the canister during the cleaning process. The method typically comprises removing a cap from the upper end of the canister, removing from the interior of the canister the sprinkler head assembly, and attaching to the canister the lower end of a device, to direct flushing water outwardly from the canister and away from the site of the canister.

The device of the invention is adapted to work with those large surface area sprinkler systems, which usually have large canisters serving as sprinkler head housings. Devices of this type are frequently used for large surface area irrigation, as for example, along freeways and highways, in parks and other recreation areas, and the like. This is to be distinguished from the relatively small diameter sprinkler systems which cover very limited surface areas, as for example, those sprinkler systems used with residential homes and the like.

This invention possesses many other advantages and has other purposes which may be made more clearly apparent from a consideration of the forms in which it may be embodied. These forms are shown in the drawings forming a part of and accompanying the present specification. They will now be described in detail for purposes of illustrating the general principles of the invention. However, it is to be understood that the following detailed description and the accompanying drawings are not to be taken in a limiting sense.

### BRIEF DESCRIPTION OF THE DRAWINGS

Having thus described the invention in general terms, reference will now be made to the accompanying drawings in which:

FIG. 1 is a side elevational view of a water sprinkler head mounted in a subterranean position, with which the clean-out apparatus of the present invention may be employed;

FIG. 2 is an exploded vertical sectional view, showing the water sprinkler head and its arrangement with respect to a subterranean water line;

FIG. 3 is a side elevational view of the subterranean mounted sprinkler head, with a pop-up shaft in the extended position;

FIG. 4 is a vertical sectional view, similar to FIG. 2, and showing the sprinkler head assembly with the pop-up shaft in the extended position;

FIG. 5 is an exploded side elevational view, partially in section, and showing disassembly of the sprinkler head of FIG. 1;

FIG. 6 is a side elevational view, showing a clean-out attachment in relation to the sprinkler head of FIG. 5, with the interior components thereof removed; and

FIG. 7 is an exploded side elevational view, partially in section, and showing the clean-out attachment in a position where it is ready to be disposed on the upper end of the sprinkler head.

### DETAILED DESCRIPTION OF A PREFERRED EMBODIMENT

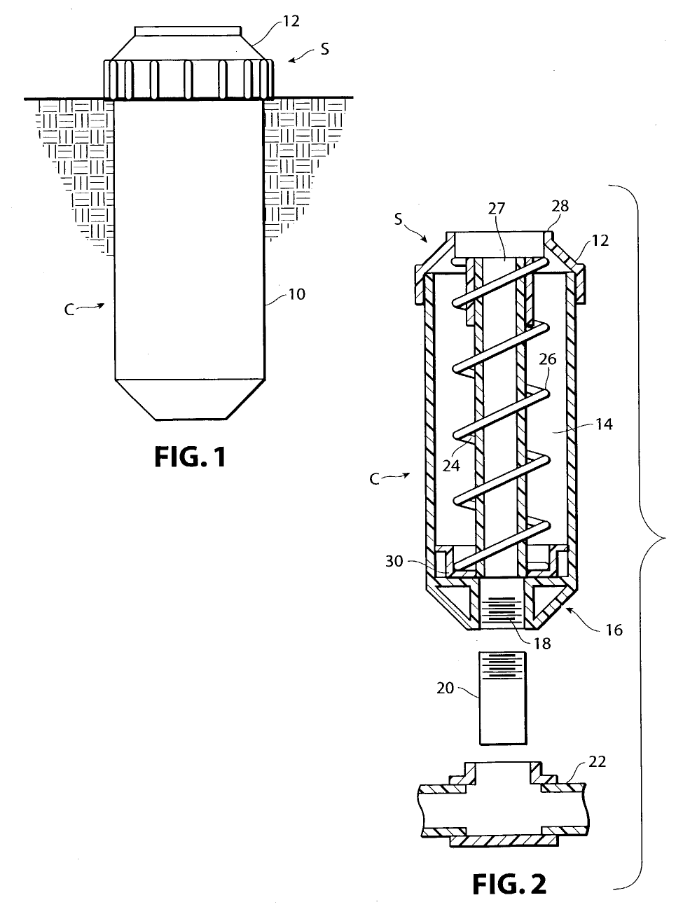

Referring now in more detail and by reference characters to the drawings, which illustrate a preferred embodiment of the present invention, A designates a clean-out apparatus enabling removal of debris from a sprinkler canister C, the latter of which is best illustrated in FIGS. 1-4 of the drawings. In this particular case, a sprinkler head S is comprised of a canister 10 with a threadedly removable and attachable cap 12, and an interior water sprinkler head mechanism 14, which is hereinafter described in more detail.

The sprinkler head mechanism 14 is removable from the sprinkler head canister 10 and, in this embodiment, the mechanism is shown as a pop-up sprinkler head mechanism. The sprinkler head canister typically has a lower end 16 with an internally threaded bore 18, for attachment to an upstanding pipe 20 connected to a subterranean water line 22, which delivers water under pressure.

These sprinkler heads, with which the present invention is concerned, are usually so-called “large diameter pipe sprinkler heads”, that is, canisters which have a diametral size ranging from 1⅜ inches at a minimum to about 2½ inches. As an example, some of the sizes with which the device of the invention may be used, are 1⅜ inch diameter canisters, 1⅞ inch canisters, 2⅜ inch canisters, 1⅝ inch canisters, 2 inch canisters and 2½ inch canisters.

Conventional pop-up sprinkler heads include a pop-up shaft 24 which is biased by means of a coil spring 26, to be urged back into the canister 10. Thus, when the sprinkler pop-up shaft is biased upwardly by water pressure so that the upper end 28 is extended beyond the canister, a spray head 28 at the upper end of the shaft is biased outwardly and upwardly of the canister C and the cap 12. This is due to the fact that water under pressure bears against the lower end of the pop-up shaft and forces the same to an upwardly or outwardly extended position. The pop-up shaft 24 is provided with a lower plate 30 which receives water under pressure to thereby bias the sprinkler head outwardly. As indicated above, the pop-up shaft will automatically return to its nested position within the housing when the water pressure is released, by means of the action of the compression spring 26.

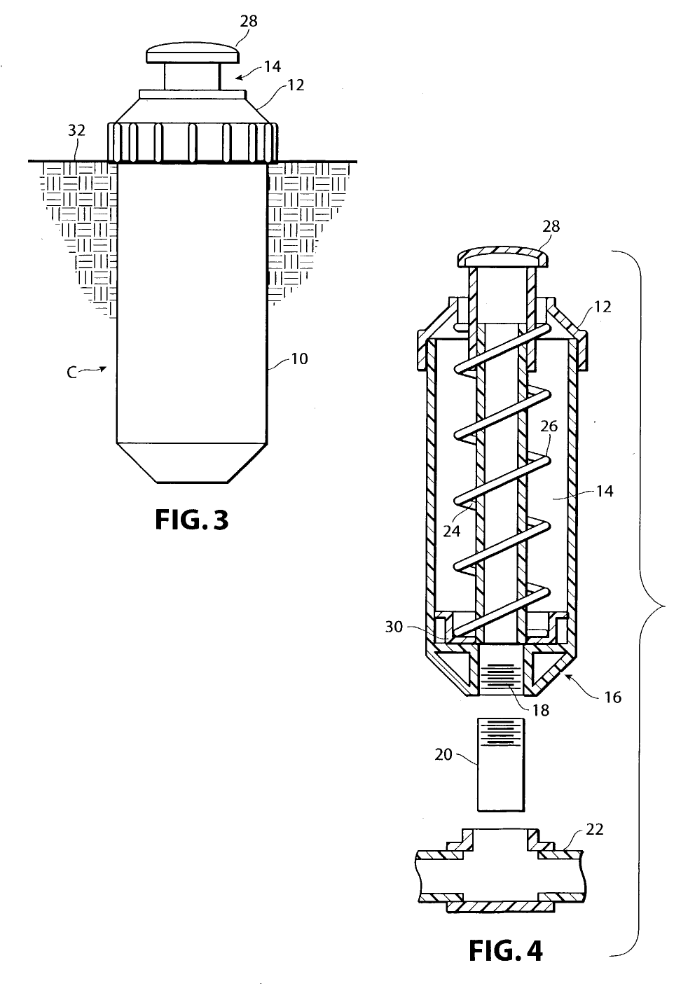

By reference to FIGS. 1 and 3, it can be observed that the cap 12 is located, and hence the upper end of the canister 10 is located, at a ground surface 32. One of the problems, therefore, arising, when there is a need for clean-out or repair or other maintenance of the sprinkler head assembly, is the fact that dirt or other debris tends to fall within the canister to the lower end of the canister, after removal of the cap 12. It is also to be noted that FIGS. 3 and 4 illustrate the pop-up shaft forming part of the sprinkler head in the extended position, permitting spray of water therefrom.

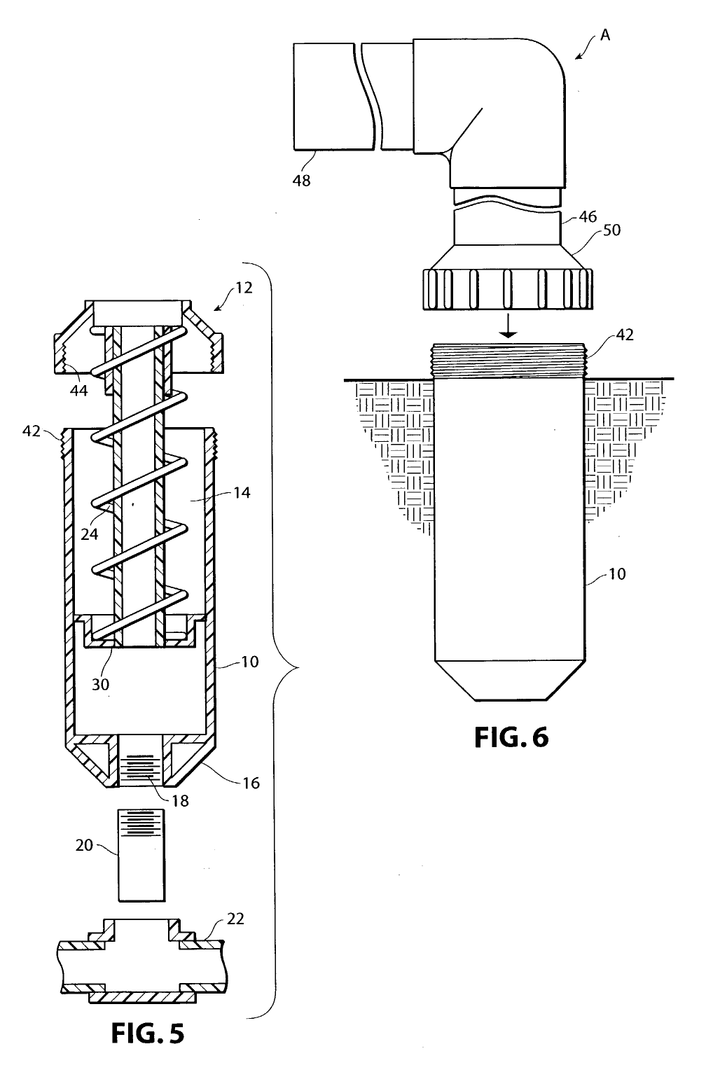

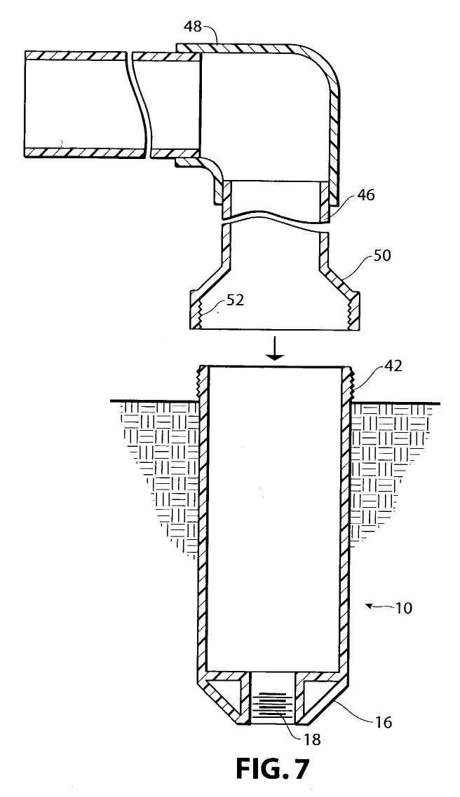

FIG. 5 illustrates the disassembly of the sprinkler head assembly with the cap 12 removed from the canister. FIGS. 6 and 7 illustrate a flushing device in accordance with the present invention, and which is designed for use with the sprinkler canister 10 when the cap 12 is removed. By reference to FIG. 6, it can be observed that the cap 12 is removed, thereby permitting removal of the pop-up shaft assembly. When the pop-up shaft assembly has been removed, the canister 10 is essentially empty and opened for access. Thus, the pop-up mechanism can be cleaned or repaired as may be required and reinstalled.

After the pop-up assembly has been cleaned, it is usually necessary to flush out the entire canister. This is due to the fact that small particles of debris which are carried in the water are introduced into the sprinkler head. Moreover, and one of the significant problems, is the fact that dirt and other debris almost inevitably falls into the canister when the lid is removed.

The upper end of the canister is located at a ground level, and after a period of time may even sink so that it is located below a ground level. Consequently, removal of the cap almost necessarily results in debris falling into the canister. Consequently, if the canister is not flushed, it will be necessary for the same maintenance personnel to conduct the same operation again.

FIG. 6 illustrates the clean-out apparatus A, in accordance with the present invention, located in relation to the open upper end of the canister 10. In this case, the canister 10 is normally provided with an externally threaded upper end 42, adapted to receive internal threads 44 on the skirt of the cap 12. The clean-out apparatus is generally L-shaped in construction, including a leg 46 which extends co-parallel to the central axis of the canister, and a second leg 48 angularly located to the leg 46. In this case, the leg 48 preferably extends at an angle from about 15° to about 160°. Even more preferably, the leg 48 extends at an angle of about 90° relative to the leg 46. In another preferred embodiment, the leg 48 may extend at an angle of about 135° relative to the axis passing through the leg 46.

The leg 46 is provided at its lower end with an outwardly flaring flange 50 containing an interior threaded section 52 adapted for threaded engagement with the externally threaded section 42 on the canister. Thus, when the cap 12 is removed, the clean-out apparatus can be threadedly attached to the upper end of the canister. After the clean-out apparatus is so attached, water can then be turned on at full pressure and which allows the pressurized water to literally force out all debris in the canister out of the canister. Moreover, and one of the important aspects of the invention, is the fact that the water and the debris contained therein, does not fall back into the region of the sprinkler head. Otherwise, that area would become very quickly saturated, and clearly interfere with further maintenance of the sprinkler head. After complete flushing of the canister, the clean-out apparatus is then threadedly removed from the canister, the pop-up assembly reinserted into the canister, followed by reattachment of the cap 12. This simple process thereby allows for easy and effective cleaning of a canister and repair of the assembly therein, without saturating the area of the canister with water during the flushing process.

The device of the invention may be made of a variety of materials including, for example, the same plastic material used in the formation of the sprinkler head. Otherwise, other materials of construction could be used as well.

Thus, there has been illustrated and described a unique and novel apparatus for flushing debris from a sprinkler head canister and which thereby fulfills all of the objects and advantages which have been sought. It should be understood that many changes, modifications, variations and other uses and applications which will become apparent to those skilled in the art after considering the specification and the accompanying drawings. Therefore, any and all such changes, modifications, variations and other uses and applications which do not depart from the spirit and scope of the invention are deemed to be covered by the invention.

Having thus described the invention, what I desire to claim and secure by letters patent is:

1. A subterranean sprinkler system clean-out apparatus for efficiently and rapidly removing debris from a subterranean sprinkler head canister of a large surface area sprinkler mechanism, and which is located below a ground surface and other debris which might otherwise fall into the canister when a cap therefor is removed, said clean-out apparatus comprising:
a) a first tubular leg having a first duct which extends and communicates with said canister and which has an end located to be attached to an upper end of said canister; and
b) a second tubular leg extending above said ground surface and forming part of said apparatus and also having a second duct communicating with said first duct, said second leg being connected to and located to extend angularly away from said first leg to thereby direct any water or debris in the canister away from the vicinity of the sprinkler head canister.

2. The subterranean sprinkler system clean-out apparatus of claim 1 further characterized in that said second leg extends outwardly away from said first leg at a substantial angle.

3. The subterranean sprinkler system clean-out apparatus of claim 1 further characterized in that said second leg extends outwardly away from said first leg at an angle between the range of about 15° to 160°.

4. The subterranean sprinkler system clean-out apparatus of claim 1 further characterized in that said second leg extends outwardly away from said first leg at an angle of about 90°.

5. The subterranean sprinkler system clean-out apparatus of claim 1 further characterized in that said canister has an upper end with an attachment means for attachment of a cap thereto, and said first leg has a lower end which is adapted for releasable attachment to the attachment means on the upper end of said canister.

6. The subterranean sprinkler system clean-out apparatus of claim 1 further characterized in that an upper end of said canister has a threaded attachment end for receiving a cap, and said first leg has a threaded end at its lower end sized for threaded attachment to the threaded attachment end of said canister.

7. The subterranean sprinkler system clean-out apparatus of claim 1 further characterized in that said duct has a diameter of approximately the same size as an inner wall of said canister.

8. The subterranean sprinkler system clean-out apparatus of claim 5 further characterized in that said duct has a second end and said interior duct extending therebetween which is generally of consistent diameter with the duct of said first leg.

9. A method for cleaning out a canister of a large surface area subterranean sprinkler head assembly with efficient removal of debris in the canister to a position remote from the site of the canister, said method comprising:
a) removing a cap from an upper end of said canister;
b) removing from the interior of said canister a sprinkler assembly; and
c) attaching to said upper end of said canister a device to direct flushing water introduced into said canister outwardly away from the site of said canister.

10. The method of claim 9 further characterized in that said method comprises threadedly removing said cap and threadedly attaching said device to said canister.

11. The method of claim 10 further characterized in that said method comprises threadedly attaching a generally L-shaped device having a first leg with a first end located above a ground surface and a second leg attached to said first end extending away from the site of the canister.

12. The method of claim 9 further characterized in that said method comprises threadedly attaching to said upper end of said canister a generally L-shaped device having a duct extending therethrough which is of diameter generally consistent with the diameter of the canister.

13. A combination of a wide area water sprinkler assembly and attachment therefor which allows for efficient and rapid cleaning of a subterranean canister forming part of said assembly, said combination comprising:
a) a canister having an interior chamber and mounted in soil where the upper end is at a depth which would potentially allow soil surrounding an opening at a soil surface from falling into said canister;
b) a water sprinkler mechanism in said canister;
c) a cap located over the upper end of said canister and generally enclosing a portion of said sprinkler mechanism, said cap being removable therefrom to allow access to the interior of said canister and the water sprinkler mechanism therein; and
d) a device having a pair of legs angulated with respect to one another with a duct means extending therethrough attachable to said canister when an opening is formed in the soil leading to said canister and cap and said cap is removed and said device is attached thereto, said duct then being in communication with said interior chamber and allowing any water and debris in said chamber to be ejected from the chamber from the site of the canister.

14. The combination of claim 13 further characterized in that said device comprises:
a) a first tubular leg having a first duct which extends to and communicates with said canister and which has an end located to be attached to an upper end of said canister; and
b) a second tubular leg extending above said ground surface and forming part of said apparatus and also having a second duct communicating with said first duct, said second leg being connected to and located to extend angularly away from said first leg to thereby direct any water or debris in the canister away from the vicinity of the sprinkler head canister.

15. The combination of claim 13 further characterized in that said second leg extends outwardly away from said first leg at a substantial angle.

16. The combination of claim 13 further characterized in that said second leg extends outwardly away from said first leg at an angle between the range of about 15° to 160°.

17. The combination of claim 13 further characterized in that said second leg extends outwardly away from said first leg at an angle of about 90°.

18. The combination of claim 13 further characterized in that an upper end of said canister has a threaded attachment end for receiving a cap and said first leg has a threaded end at its lower end sized for threaded attachment to the threaded attachment end of said canister.
